(19) United States
(12) Patent Application Publication
(10) Pub. No.: US 2008/0008455 A1
(43) Pub. Date: Jan. 10, 2008

(54) Cpi data for steam buffer channels

(75) Inventors: Alphonsus Anthonius Jozef De Lange, Eindhoven (NL); I-Chih Kang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/549,539

(22) PCT Filed: Mar. 17, 2004
(86) PCT No.: PCT/IB04/50273

§ 371 Date: May 8, 2006

(30) Foreign Application Priority Data
Mar. 20, 2003 (EP) 03100724.8

(51) Int. Cl. G11B 27/00; G11B 20/00; H04N 5/00

(52) U.S. Cl. 386/125; 386/46

(57) ABSTRACT

A method and apparatus for performing trickplay operations on a multimedia playback device is disclosed. When a trickplay request is received during regular multimedia playback, the appropriate frame for processing at a last processing means is determined in response to the trickplay request. The appropriate frame from a buffer is retrieved using meta data stored in the buffer which identifies the frame and the retrieved frame is processed. Meanwhile, a second appropriate frame in the stored multimedia content is selected for processing by a first processing means in response to the trickplay request. The second appropriate frame and subsequently selected frames are then processed so that the second appropriate frame is available to the last processing means when the last processing means has completed processing of the retrieved frame.

The invention relates to video processing of stored multimedia content, and more particularly to a method and apparatus for improving trickplay operations during playback of the multimedia content.

In the case of hard disk recording, often so-called CPI (characteristic Point Information) data is generated during the recording process. Typically, the CPI data is stored in a different file on the storage medium than the raw video data. This is more convenient than storing all video and CPI data together in one file.

The CPI data is used to enable more advanced playback of recorded video programs, e.g., fast/slow forward/backward playback. Typical information required to enable such trickplay operations is the offset in the raw video data file where I-frames start. In the CPI file, a timestamp is associated with each I-frame, to facilitate jumping in stored video streams, based on the time information. This way, a playback component knows which parts it needs to read from the video file and send to a connected decoder for fast playback/reverse. If a player component would read all frames in fast forward/reverse mode, this could overload the decoder, hard disk, communication and memory bandwidth of the system. In present systems, when a trickplay mode is selected, all of the stream buffers associated with the video processing elements of the system need to be flushed and filled again with the appropriate frames for the selected trickplay mode. This can cause unacceptable delay problems in displaying the multimedia content. Thus, there is a need for a new method for implementing trickplay modes of operation which do not have the delay problems associated with known playback systems.

The invention overcomes the deficiencies of other known video playback systems by supplying the CPI data to each stream buffer in the video processing stream so that each processing element can locate separate frames in the video stream during trickplay modes of operation.

According to one embodiment of the invention, a method and apparatus for performing trickplay operations on a multimedia playback device is disclosed. When a trickplay request is received during regular multimedia playback, the appropriate frame for processing at a last processing means is determined in response to the trickplay request. The appropriate frame from a buffer is retrieved using meta data stored in the buffer which identifies the frame and the retrieved frame is processed. Meanwhile, a second appropriate frame in the stored multimedia content is selected for processing by a first processing means in response to the trickplay request. The second appropriate frame and subsequently selected frames are then processed so that the second appropriate frame is available to the last processing means when the last processing means has completed processing of the retrieved frame.

These and other aspects of the invention will be apparent from and elucidated with reference to the embodiments described hereafter.

The invention will now be described, by way of example, with reference to the accompanying drawings, wherein:

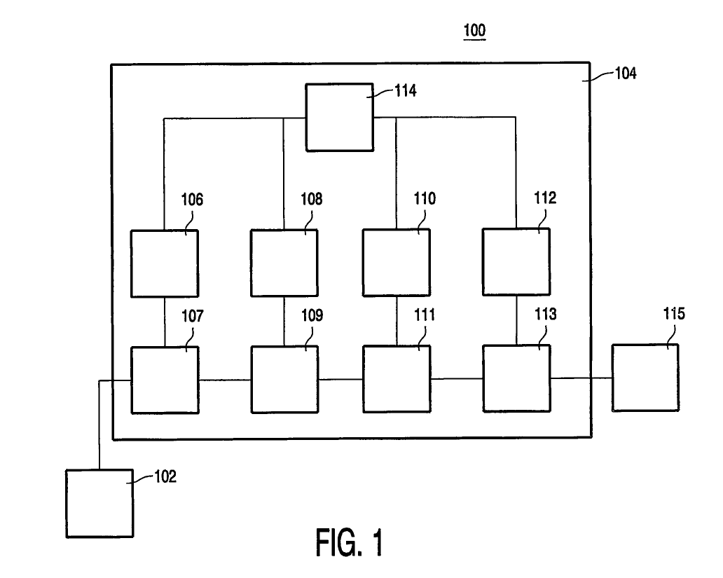

FIG. 1 is a block diagram of a multimedia playback device according to one embodiment of the invention; and

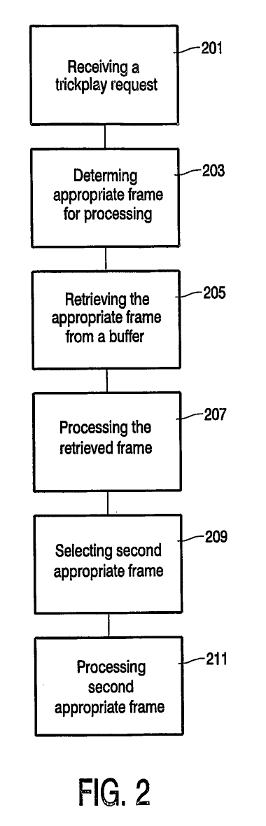

FIG. 2 is a flow chart illustrating a trickplay operation according to one embodiment of the invention.

Instead of just using CPI information for stored video streams on disk, the invention uses the CPI information in each stream buffer that implements a communication channel between two A/V processing components. In C-HEAP, as proposed in patent application with internal reference PHNL021390, a communication channel consists of one or more buffers that can be used to store A/V data written by a producer and read by a consumer. In the C-HEAP communication protocol, a buffer must first be claimed (reserved) before it can be written. When it has been written, the producer must release it, before a consumer can read it. While writing A/V data to a channel buffer, CPI data can be generated as well, where the CPI data identifies the locations of the I-frames in the buffer being written. The CPI data may be transported in a separate channel or may be a reserved part of the channel buffer being written.

An exemplary playback system 100 is illustrated in FIG. 1. The playback system 100 is comprised of a disc or storage device 102, a playback device 104 and a display device 115. In this illustrative example, the playback device 104 is composed of a player or disc reader 106 and an associated buffer 107, a decryption device 108 and an associated memory 109, a demultiplexer 110 and an associated memory 111, a decoder 112 and an associated buffer 113, and a processor 114 for controlling the operation of the playback device 104. For example, if the video stream from the disc 102 is not encrypted, the playback device would not need the decryption device 108 and its associated buffer 109. Furthermore, while the buffers have been shown as being separate from the respective processing elements, it will be understood that the buffers can also be a part of the respective processing elements and the invention is not limited thereto. In addition, all buffers and memory (107, 109, 111, 113) may be part of one shared memory or several shared memories. Furthermore, the playback device 104 may also include other processing elements or have fewer processing elements than those illustrated in FIG. 1 based upon the specific needs and requirements for reading different multimedia content and the invention is not limited thereto.

During playback, the player 106 reads the stored video data out of the disc 102 and puts the data in the buffer 107. For a typical MPEG A/V stream of sufficient quality, a bitrate of approximately 4 Mbit/sec is required. With 25 frames per second, on the average approximately 20 kBytes are required to store a frame. A typical GOP size of 12 means that a complete GOP can be stored in 240 kB of memory. A 1-MB stream buffer then typically contains 4 I-frames. In addition, the meta data (CPI data) for the stored data is also read into the buffer 107. Data processed by “player” 106 is put into buffer 107, which can be directly read by the next processing element “decryptor” 108. There is no need for a buffer to be completely “full” before data is read from it. Furthermore, all buffers are typically part of a single memory, such that no copying is required between buffer memory spaces. More precisely, data written by a player 106 to a buffer space 107 can directly be read by a next processing element (decryptor 108). Once there is sufficient data in the buffer 107, the oldest data is transferred to the buffer 109. The decryption device 108 then begins decrypting the video data in the buffer 109. The decrypted data is then stored in the buffer 109 until it the next processing element (demux 110) starts reading from its input buffer. The demultiplexer 110 then demultiplexes the decrypted data. When the demultiplexed data is read out of the buffer 111 (and possibly transferred to the buffer 113), the decoder 112 decodes the demultiplexed data. When the decoded data is read out of the buffer 113 by a display device 115, the decoded data can be displayed.

A method for performing trickplay operations on a multimedia playback device will now be described with reference to FIG. 2. In step 201, a trickplay request is received during regular multimedia playback by the processor 114. The appropriate frame for processing at a last processing means (decoder 113) is determined in response to the trickplay request in step 203. The appropriate frame from a buffer is retrieved using meta data stored in the buffer which identifies the frame in step 205 and the retrieved frame is processed in step 207. Meanwhile, a second appropriate frame in the stored multimedia content is selected for processing by a first processing means in response to the trickplay request in step 209. The second appropriate frame and subsequently selected frames are then processed so that the second appropriate frame is available to the last processing means when the last processing means has completed processing of the retrieved frame in step 211.

When going from normal playback to a fast forward mode of operation, it is no longer necessary to flush all channel buffers between the disc 102 and the decoder 112 and read only I-frames from the disc 102 and put these in the output channel of the player components. Instead, the decoder can select the I-frames directly from its input stream buffer 113, as can all of the processing elements in the processing chain. In the mean time, the player 106 can switch to reading of I-frames only. Once all I-frames have been read from an input stream buffer, according to the C-HEAP communication protocol, the buffer is released and becomes usable again by a producer. The producer will now overwrite all the data in the stream buffer, but in the fast forward mode, will now only write I-frames.

When a slow forward mode of operation is selected, the last processing element in the chain (the decoder 112 in FIG. 1) is simply put in a “low processing speed”. During the slow forward mode of operation, there is no need to select I-frames.

When a fast reverse mode of operation is requested, the last processing element in the playback device 104, e.g., the decoder 112 in the illustrative playback system illustrated in FIG. 1, selects previously processed I-frames, which are still in the input stream buffer 113. This is done by only the last processing element in the processing chain. By reserving multiple buffers in the input channel at the same time for the last processing element, it is possible to go back a number of I-frames. In the meantime, all other channels in the processing chain are flushed and the player 106 starts selecting previous I-frames from the disc 102.

Slow reverse is similar to fast reverse, but there is no need to select I-frames. The last processing element in the processing chain can begin to read frames in reverse order from its input buffer, until all channels are flushed and the player 106 has started reading earlier frames from the disc 102. For a smoother display, slow reverse is performed by reading out the output buffer 113 by display device 115 in reverse frame order. Because the decoded frames require more buffer space than compressed A/V data, only one previous output frame will be buffered there. Note that simply reading compressed frames in reverse order (for decoding) does not work, because of the structure of MPEG streams (B and P frames). This way of working does not require more processing power or bandwidth, even if reverse play is at normal speed. The whole processing chain can be working in “forward” mode, thereby optimizing disk access and decoder performance. Only the final readout of buffer 113 must be reversed. Too minimize buffer capacity, only one previous decoded frame in this embodiment of the invention is buffered there.

A problem that still remains is that when channel buffers are read or flushed, the player 106 must know which frame to read next from the disc 102 to enable the trickplay operation to go on smoothly after the last processing element in the processing chain has processed the data in its input buffers. This is typically not simply the next frame which the player has read before switching to trickplay mode because there is some pipeline delay between the player 106 and the decoder 112. As a result, the player 106 needs to find out which frame will be the last frame processed by the last processing element in the chain before it runs out of data. This can be done by checking the CPI data in the input buffer for the last frame to be processed. By getting this information for the last I-frame to be processed by the last processing element in the chain, for a specific trickplay mode, the player 106 knows which frame to retrieve next from the disc 102. For example, the processor 114 can retrieve the CPI information from the decoder 112 and buffer 113 and then route this information to the player 106 but the invention is not limited thereto.

To assure that the processing chain controller has enough time to flush all streaming buffers except for the input buffer of the last processing element in the chain, and the last processing element in the chain can finish processing the current GOP, a buffer of 240 kB is already sufficient. For fast forward/backward trickplay, probably two GOPs including 3 I-frames are sufficient. For fast reverse, with 2 GOP's of data in the input buffer in which the decoder can access the I-frames in any order, the decoder can decode and display at least one previous I-frame and at most 2 I-frames. Display of an I-frame takes 1/25th of a second (40 ms) for a typical 50 Hz interlace TV screen, or 1/30^{th} of a second for a typical 60 Hz interlace TV screen. This is the time in which all the relevant buffers must be flushed and the player 106 start reading from the hard disk 102, as well as to have the data arrive at the input channel of the decoder. A number of frames will be read in forward order from the disk, to obtain good disk access speed, and the subsequent processing elements can read out the buffer of the disk reader in reverse order. If this deadline is not met, then the decoder will run out of input data after jumping backwards 1 or 2 I-frames and the output will not be smooth. Should this time not be sufficient, then the size of the buffer of the decoder can be increased or the number of reserved buffers by the decode can be increased to overcome this problem. For example, if the decoder reserves 3 buffers of 1 GOP each at the same time, then the decoder can minimally display 2 previous frames and maximally 3 frames, allowing 2 or 3 time periods to accomplish the flushing and disc accessing.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

A method and apparatus for performing trickplay operations on a multimedia playback device is disclosed. When a trickplay request is received during regular multimedia playback, the appropriate frame for processing at a last processing means is determined in response to the trickplay request. The appropriate frame from a buffer is retrieved using meta data stored in the buffer which identifies the frame and the retrieved frame is processed. Meanwhile, a second appropriate frame in the stored multimedia content is selected for processing by a first processing means in response to the trickplay request. The second appropriate frame and subsequently selected frames are then processed so that the second appropriate frame is available to the last processing means when the last processing means has completed processing of the retrieved frame.

1. A method for performing trickplay operations on a multimedia playback device, said playback device comprising a plurality of processing means each with at least one buffer wherein the plurality of processing means process stored multimedia content in a serial manner, comprising the steps of:
receiving a trickplay request during regular multimedia playback;
determining appropriate frame for processing at a last processing means in response to said trickplay request;
retrieving the appropriate frame from a buffer using meta data stored in the buffer which identifies said frame;
processing said retrieved frame;
selecting second appropriate frame in stored multimedia content for processing by a first processing means in response to said trickplay request;
processing said second appropriate frame and subsequently selected frames so that the second appropriate frame is available to the last processing means when the last processing means has completed processing of said retrieved frame.

2. The method according to claim 1, wherein the trickplay request is for a fast forward mode of operation.

3. The method according to claim 2, further comprising the step of:
when trickplay request is received, each of said processing means determines the appropriate frame from the associated buffer for processing in response to the trickplay request.

4. The method according to claim 1, wherein the trickplay request is for a fast reverse mode of operation.

5. The method according to claim 4, wherein all buffers except for the buffer associated with the last processing means are flushed after the trickplay request is received.

6. The method according to claim 1, wherein multiple buffers are associated with the last processing means.

7. The method according to claim 4, wherein the last processing means selects at least one previously processed I-frame which is still in said buffer associated with the last processing means.

8. A multimedia playback device, comprising:
a plurality of processing means (106, 108, 110, 112) each with at least one buffer (107, 109, 111, 113) wherein the plurality of processing means process stored multimedia content in a serial manner;
means for receiving (114) a trickplay request during regular multimedia playback;
means for determining (112, 114) appropriate frame for processing at a last processing means in response to said trickplay request;
means for retrieving (112) the appropriate frame from a buffer using meta data stored in the buffer which identifies said frame;
means for processing (112) said retrieved frame;
means for selecting (106, 114) second appropriate frame in stored multimedia content for processing by a first processing means in response to said trickplay request;
means for processing (106, 108, 110) said second appropriate frame and subsequently selected frames so that the second appropriate frame is available to the last processing means (112) when the last processing means (112) has completed processing of said retrieved frame.

9. The apparatus according to claim 8, wherein the trickplay request is for a fast forward mode of operation.

10. The apparatus according to claim 9, wherein when trickplay request is received, each of said processing means determines the appropriate frame from the associated buffer for processing in response to the trickplay request.

11. The apparatus according to claim 8, wherein the trickplay request is for a reverse mode of operation.

12. The apparatus according to claim 11, wherein all buffers except for the buffer associated with the last processing means are flushed after the trickplay request is received.

13. The apparatus according to claim 8, wherein multiple buffers are associated with the last processing means.

14. The apparatus according to claim 11, wherein the last processing means selects at least one previously processed I-frame which is still in said buffer associated with the last processing means.

15. The apparatus according to claim 11, wherein a display device (115) reads frames out of the buffer of the last processing means in reverse frame order.

16. The apparatus according to claim 8, wherein said buffers are part of a single shared memory.

17. The apparatus according to claim 8, wherein said buffers are distributed over multiple memories.
